(19) United States
(12) Patent Application Publication
(10) Pub. No.: US 2015/0181161 A1
(43) Pub. Date: Jun. 25, 2015

(54) Information Processing Method And Information Processing Apparatus

(71) Applicant: Lenovo (Beijing) Co., Ltd., Beijing (CN)

(72) Inventor: Hongguang Wang, Beijing (CN)

(73) Assignee: Lenovo (Beijing) Co., Ltd., Beijing (CN)

(21) Appl. No.: 14/500,317

(22) Filed: Sep. 29, 2014

(30) Foreign Application Priority Data
Dec. 23, 2013 (CN) 201310717106.9

(51) Int. Cl. H04N 7/15

(52) U.S. Cl. CPC H04N 7/15

(57) ABSTRACT

An information processing method and an information processing apparatus are described. The method includes acquiring a first display image of a first user of a first electronic apparatus in response to establishment of a communication link between the first electronic apparatus and a second electronic apparatus; receiving, from the first electronic apparatus, first medium information including first voice information of the first user collected by the first electronic apparatus and first feature information representing feature of the first user; modifying the first display image based on the first medium information to generate a second display image; and transmitting the second display image and the first voice information to the second electronic apparatus to output the second display image and the first voice information at the second electronic apparatus.

This application claims priority to Chinese patent application No. 201310717106.9 filed on Dec. 23, 2013, the entire contents of which is incorporated herein by reference.

### BACKGROUND

This disclosure relates to field of information processing, and more particularly, this disclosure relates to an information processing method and an information processing apparatus.

With development of information technology, a network communication such as a video communication becomes more and more popular. In a procedure of such network communication, two parties of the communication can not only hear voice of other party collected by an audio input apparatus (for example, a microphone or the like) of the other party of the communication, and can also see image of the other party collected by a video input apparatus (for example, a camera head or the like) of the other party of the communication.

However, there are occasions in which a user doesn't wish to expose a figure of himself in the procedure of the network communications, for example, when the two parties of the communication are strangers or people that are not familiar, when the user doesn't wish to expose his true face due to a case of unclean individual figure at the time of establishing the communication, and so on. Due to existence of these occasions, widespread use of the video communication is hindered.

### SUMMARY

In view of the above situation, this disclosure provides an information processing method and an information processing apparatus.

According to one embodiment, there provides an information processing method comprising: acquiring a first display image of a first user of a first electronic apparatus in response to establishment of a communication link between the first electronic apparatus and a second electronic apparatus; receiving, from the first electronic apparatus, first medium information including first voice information of the first user collected by the first electronic apparatus and first feature information representing feature of the first user; modifying the first display image based on the first medium information to generate a second display image; and transmitting the second display image and the first voice information to the second electronic apparatus to output the second display image and the first voice information at the second electronic apparatus.

The first display image is generated by the following steps: acquiring a third display image; receiving adjustment information from the first electronic apparatus, wherein the adjustment information is generated by detecting the feature of the first user by the first electronic apparatus or generated by receiving instruction of the first user by the first electronic apparatus; and generating the first display image based on the third display image and the adjustment information.

The step of acquiring the third display image comprises: selecting the third display image from a plurality of candidate images based on a predetermined strategy according to reference information received from the first electronic apparatus.

The step of generating the second display image comprises: modifying the first display image based on the first feature information included in the first medium information to generate the second display image.

The step of generating the second display image comprises: execute voice recognition to the first voice information in the first medium information to obtain second feature information; and modifying the first display image based on the second feature information to generate the second display image.

The information processing method further comprises: recognizing the first voice information; converting the recognized first voice information to generate converted first voice information and third feature information; and the step of generating the second display image comprises: modifying the first display image based on the first feature information and the third feature information to generate the second display image; the step of transmitting the second display image and the first voice information to the second electronic apparatus comprises: transmitting the second display image and converted first voice information to the second electronic apparatus to output the second display image and the converted first voice information at the second electronic apparatus.

The first medium information further includes first video information of the first user collected by the first electronic apparatus, and the information processing method further comprises: acquiring communication status information representing communication status of the communication link before generating the second display image, wherein the communication status information is received from at least one of the first electronic apparatus and the second electronic apparatus or detected by a server; determining whether the communication status information satisfies a switching condition; generating the second display image and transmitting the second display image and the first voice information to the second electronic apparatus in the case that the communication status information satisfies the switching condition; transmitting the first video information and the first voice information to the second electronic apparatus in the case that the communication status information does not satisfy the switching condition, wherein, amount of data transmitted of the second display image is less than amount of data transmitted of the first video information.

According to another embodiment, there provides an information processing method comprises: collecting first voice information of a first user in response to establishment of a communication link between a first electronic apparatus and a second electronic apparatus; detecting a figure of the first user to generate first feature information representing the figure of the first user; and transmitting the first voice information and the first feature information to a server as first medium information to make the server execute a modifying operation based on the first medium information and transmit the first voice information and a second display image as a result of the modifying operation to the second electronic apparatus; or transmitting the first voice information and the first feature information to the second electronic apparatus to make the second electronic apparatus execute an modifying operation; wherein, the modifying operation comprises: acquiring the first display image and modifying the first display image based on the first medium information to generate the second display image.

The information processing method further comprises: collecting first video information of the first user by a camera unit in response to the establishment of the communication link between the first electronic apparatus and the second electronic apparatus; detecting communication status information representing communication status of the communication link; determining whether the communication status information satisfies a switching condition; and transmitting the first voice information and the first feature information as first medium information to the server in the case that the communication status information satisfies the switching condition; transmitting the first voice information and the first video information to the second electronic apparatus through the server in the case that the communication status information does not satisfy the switching condition.

Amount of data transmitted of the second display image is less than amount of data transmitted of the first video information.

According to another embodiment, there provides an information processing apparatus including: a first acquiring unit for acquiring a first display image of a first user of a first electronic apparatus in response to establishment of a communication link between the first electronic apparatus and a second electronic apparatus; a first receiving unit for receiving, from the first electronic apparatus, first medium information including first voice information of the first user collected by the first electronic apparatus and first feature information representing feature of the first user; a first generating unit for modifying the first display image based on the first medium information to generate a second display image; and a transmitting unit for transmitting the second display image and the first voice information to the second electronic apparatus to output the second display image and the first voice information at the second electronic apparatus.

The information processing apparatus further includes: a second acquiring unit for acquiring a third display image; a second receiving unit for receiving adjustment information from the first electronic apparatus, wherein the adjustment information is generated by detecting the feature of the first user by the first electronic apparatus or generated by receiving instruction of the first user by the first electronic apparatus; and a second generating unit for generating the first display image based on the third display image and the adjustment information.

The second acquiring unit is configured to: select the third display image from a plurality of candidate images based on a predetermined strategy according to reference information received from the first electronic apparatus.

The first generating unit includes: a first modifying unit for modifying the first display image based on the first feature information included in the first medium information to generate the second display image.

The first generating unit includes: a recognizing unit for executing voice recognition to the first voice information in the first medium information to obtain second feature information; and a second modifying unit for modifying the first display image based on the second feature information to generate the second display image.

The information processing apparatus further includes: a recognizing unit for recognizing the first voice information; a converting unit for converting the recognized first voice information to generate converted first voice information and third feature information; and, the first generating unit includes: a third modifying unit for modifying the first display image based on the first feature information and the third feature information to generate the second display image; the transmitting unit further transmits the second display image and the converted first voice information to the second electronic apparatus to output the second display image and the converted first voice information at the second electronic apparatus.

The first medium information further includes first video information of the first user collected by the first electronic apparatus, and the information processing apparatus further includes: a third acquiring unit for acquiring communication status information representing communication status of the communication link before generating the second display image, wherein the communication status information is received from at least one of the first electronic apparatus and the second electronic apparatus or detected by a server; a determining unit for determining whether the communication status information satisfies a switching condition; and, the transmitting unit is configured to generate the second display image and transmit the second display image and the first voice information to the second electronic apparatus in the case that the communication status information satisfies the switching condition; transmit the first video information and the first voice information to the second electronic apparatus in the case that the communication status information does not satisfy the switching condition, wherein, amount of data transmitted of the second display image is less than amount of data transmitted of the first video information.

According to another embodiment, there provides an information processing apparatus including: a first collecting unit for collecting a first voice information of a first user in response to establishment of a communication link between a first electronic apparatus and a second electronic apparatus; a first detecting unit for detecting a figure of the first user to generate first feature information representing the figure of the first user; and a transmitting unit for transmitting the first voice information and the first feature information to a server as first medium information to make the server to execute a modifying operation based on the first medium information and transmit the first voice information and a second display image as a result of the modifying operation to the second electronic apparatus; or transmitting the first voice information and the first feature information to the second electronic apparatus to make the second electronic apparatus execute the modifying operation; wherein, the modifying operation comprises: acquiring the first display image and modifying the first display image based on the first medium information to generate the second display image.

The information processing apparatus further includes: a second collecting unit for collecting first video information of the first user by a camera unit in response to the establishment of the communication link between the first electronic apparatus and the second electronic apparatus; a second detecting unit for detecting communication status information representing communication status of the communication link; and a determining unit for determining whether the communication status information satisfies a switching condition; the transmitting unit is configured to transmit the first voice information and the first feature information as the first medium information to the server in the case that the communication status information satisfies the switching condition; transmit the first voice information and the first video information to the second electronic apparatus through the server in the case that the communication status information does not satisfy the switching condition.

Amount of data transmitted of the second display image is less than amount of data transmitted of the first video information.

### BRIEF DESCRIPTION OF THE DRAWINGS

FIG. 1 is a flow chart illustrating the information processing method according to one embodiment of this disclosure.

FIG. 2 is a flow chart illustrating the information processing method according to another embodiment of this disclosure.

FIG. 3 is a block diagram illustrating main configuration of the information processing apparatus according to the embodiments of this disclosure. and

FIG. 4 is a block diagram illustrating main configuration of the information processing apparatus of according to another embodiment of this disclosure.

### DETAILED DESCRIPTION

The embodiments of this disclosure is described detailed with reference to the accompanying drawings hereinafter.

Firstly, the information processing method according to the embodiments of this disclosure is described.

The information processing method of the embodiments is applied in a server. The server may communicate with a plurality of electronic apparatus such as a first electronic apparatus and a second electronic apparatus. The first electronic apparatus and the second electronic apparatus are the electronic apparatus having communication function for example a mobile phone, a tablet computer or a PC or the like. In particular, in a procedure of communication, the first electronic apparatus may send the communication information (for example, voice information, video information or the like) to the server. The server receives the communication information from one of the first electronic apparatus and the second electronic apparatus, and forwards it to the other of the first electronic apparatus and the second electronic apparatus, so as to implement communication between the first electronic apparatus and the second electronic apparatus.

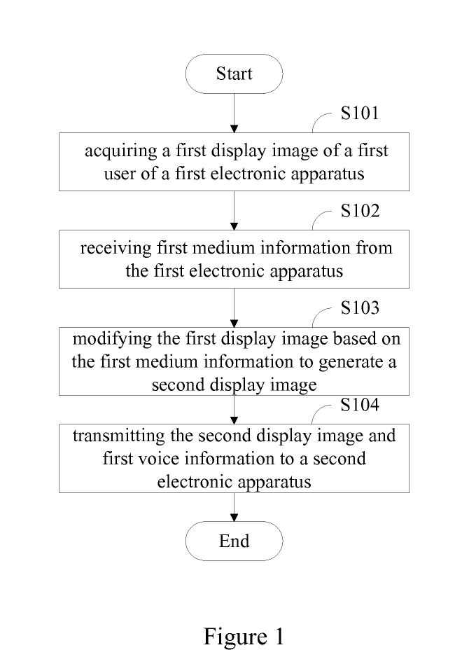

Hereinafter, the information processing method according to the embodiments is described with reference to FIG. 1.

As shown in FIG. 1, when the information processing method of the embodiment starts, a communication link is established between the first electronic apparatus and the second electronic apparatus firstly, that is, the first electronic apparatus starts to communicate with the second electronic apparatus. Therefore, in step S101, the information processing method acquires a first display image of a first user of the first electronic apparatus in response to establishment of the communication link between the first electronic apparatus and the second electronic apparatus. That is, the information processing method acquires the first display image of a first account corresponding to the first user logging in the first electronic apparatus.

Being different from an image of a real figure of the first user collected by a camera head of the first electronic apparatus in conventional video communication, in the embodiments, the first display image is not the image collected by the camera head but an image representing a virtual figure of the first user of the first electronic apparatus.

In particular, the first display image may be the virtual figure generated in advance or in the procedure of communication based on the real figure of the first user.

More particularly, in one example, the first display image may be generated by the following steps. Firstly, the information processing method acquires a third display image. The third display image may be an image of a reference figure corresponding to the first display image. For example, in case that the first display image is an image representing facial figure of the first user, the third display image may be an image of reference facial figure. Also for example, in case that the first display image is an image representing half body/full body figure of the first user, the third display image may be an image of reference half body/full body figure. Hereinafter, in order for convenience of description, the third display image is referred as a reference figure/image and the first display image is referred as a virtual figure/image as appropriate.

Further, the third display image may be stored in the server in advance. Alternatively, the third display image may also be acquired from an external storage (for example, the first electronic apparatus, the second electronic apparatus or other server or the like) as necessary.

Next, the information processing method may receive adjustment information from the first electronic apparatus. The adjustment information is for adjusting the reference figure to make the reference figure to more conform to information of the real figure of the user. For example, in case that the reference figure is a facial figure, the adjustment information may include information about details (features) such as facial features, hairstyle, shape of lip, color of skin, color of hair, texture or the like.

In one example, the adjustment information is generated by the first electronic apparatus according to instruction of the first user and transmitted from the first electronic apparatus to the server. In particular, the first electronic apparatus may acquire the reference figure and present the reference figure to the first user. Further, the first electronic apparatus may also present alternative option about the above-described various kinds of features to the first user. The alternative option may be presented in form of a graphics and displayed overlapping with/replacing the reference figure according to selection of the user to facilitate the user to preview adjusted result intuitionally and to confirm. Then, the first electronic apparatus receives the selection and confirmation about various kinds of features of the user and generates the adjustment information correspondingly thereby.

In another example, the adjustment information is generated automatically by the first electronic apparatus detecting features of the first user and transmitted from the first electronic apparatus to the server. In particular, in one aspect, the first electronic apparatus may acquire the reference figure. On the other hand, for example, the first electronic apparatus may detect the feature of the first user for example the above-described facial features, hairstyle, shape of eyebrows, color of skin, color of hair, texture or the like through the camera head. Next, the first electronic apparatus compares the features and the reference figure automatically to generate the adjustment information. Detail of comparison processing is known for those skilled in field of image processing, and it is no longer described detailed here. Of course, the above manner of detecting the features of the first user to generate the adjustment information is only an example. The skilled in the art can generate the adjustment information according to various kinds of other techniques, and they are all in range of this disclosure.

After the information processing method acquires the adjustment information from the first electronic apparatus through the above-described various kinds of manners, the information processing method generates the first display image based on the third display image and the adjustment information.

In particular, the information processing method may adjust according to the adjustment information on a basis of the third display image (the reference figure) to generate the first display image (the virtual figure). The information processing method may adopt various kinds of conventional image processing method to generate the first display image, and it is no longer described detailed here.

Further, about the above-described reference figure, the information processing method may acquire a unique image as the above-described reference figure. Alternatively, the information processing method may also select one of a plurality of candidate images as the reference figure for the first user based on a predetermined strategy.

In particular, in one embodiment, in the information processing method, the plurality of candidate images, for example, candidate images for different genders, candidate images for different races or the like may be pre-stored.

Further, the information processing method may receive a piece of reference information from the first electronic apparatus in advance. The reference information is reference information for helping the server to select from the plurality of candidate images. In the first example, the reference information may be audio information of the first user of the first electronic apparatus. Therefore, the information processing method recognizes that the gender of the first user is female by analyzing the audio information, to select candidate image of female from the plurality of candidate images as the reference figure.

In the second example, the information processing method recognizes language of the first user by executing voice recognition to the audio information to determine the race of the first user, so as to select candidate image of corresponding race from the plurality of candidate images as the reference figure.

In the third example, the reference information may be geographic position information of the first user of the first electronic apparatus. Therefore, the information processing method may determine the race of the first user through the geographic position information, to select the candidate image of the corresponding race from the plurality of candidate images as the reference figure.

In the fourth example, the reference information may be image/video information of the first user of the first electronic apparatus, that is, image/video of the first user collected by the camera head of the first electronic apparatus. Therefore, the information processing method may execute image recognition to the image/video to execute match of degree of similarity with the plurality of candidate images, and select a candidate image with highest match of degree of similarity from the plurality of candidate images as the reference figure.

It needs to note that, the above various kinds of reference information and the corresponding strategies and processing modes are only examples. Those skilled in the art can design other various kinds of reference information and corresponding strategies and processing methods on this basis, and they are all in the range of this disclosure. Further, those skilled in the art can combine the various kinds of reference information and the strategies thereof, to select a most suitable reference figure more accurately.

With the above processing, the information processing method can select a closest reference figure for the user automatically according to feature of the user so as to reduce the adjustment information generated hereafter, and can reduce amount of data processed and amount of data transmitted in a procedure of generating the virtual figure based on the adjustment information, which improves processing efficiency.

After acquiring the virtual figure of the first user with the above-described processing in step S101, in step S102, the information processing method receives first medium information from the first electronic apparatus.

In particular, the first medium information may include first voice information of the first user collected by the first electronic apparatus and first feature information representing feature of the first user.

More particularly, the first voice information is voice information generated in the procedure of communication by the first user. The first feature information is information of a change of the feature of the first user generated in the procedure of communication, for example, information about change of facial expression, change of mouth shape, change of gesture of the user or the like. The first feature information is obtained by detecting the first user by the camera head of the first electronic apparatus and executing the image recognition.

Next, in step S103, the information processing method modifies the first display image based on the first medium information to generate the second display image.

In particular, in one embodiment, the information processing method may modify the first display image based on the first feature information included in the first medium information to generate the second display image. The information processing method may adopt the various kinds of image processing modes, for example, a mode similar to the processing mode of modifying the reference figure based on the adjustment information to generate the virtual figure, to modify the virtual figure based on the first feature information to generate the second display image, i.e., a real time virtual figure reflecting a real time change of the first user in the procedure of communication.

In another embodiment, the first generating unit may execute voice recognition to the first voice information in the first medium information to obtain second feature information. Hereafter, the information processing method modifies the first display image based on the second feature information to generate the second display image. For example, the information processing method may obtain language information of the first user as the second feature information through the voice recognition. Then, the information processing method may acquire action of lip (mouth shape) corresponding to the language information based on the language information, so as to modify the first display image based on the action of lip to generate the second display image.

Further, in another embodiment, it assumes that a first kind of language of the first user at the first electronic apparatus side is different from a second kind of language of second user at the second electronic apparatus side, and the information processing method may also convert the languages automatically.

In particular, in this embodiment, the information processing method may recognize the first voice information and convert, i.e., translate the recognized first voice information, to generate converted first voice information and third feature information. A kind of language of the converted first voice information corresponds to the second kind of language. The third feature information is information of an action of lip corresponding to a meaning corresponding to the first voice information in the second kind of language. Therefore, the information processing method modifies the first display image based on the third feature information. Of course, at this time, the information processing method may also modify the first display image based on the first feature information. Then, the information processing method transmits the second display image and the converted first voice information to the second electronic apparatus to output the second display image and the converted first voice information at the second electronic apparatus.

Therefore, in the generated second display image, not only change of expression of the first user (for example, blink or the like) obtained based on the first feature information but also change of action of lip of the first user obtained based on the third feature information can be reflected. Also, in this embodiment, the information processing method translates language of the user of different kinds of language automatically and convert into corresponding action of lip, so as to implement smooth communication between the user of different kinds of language, and the displayed action of lip of the virtual figure is consistent with language heard by recipient party, which further improve the user's experience.

After generating the second display image through the above-described operation in step S103, in step S104, the information processing method transmits the second display image and the first voice information to the second electronic apparatus, to output the second display image and the first voice information at the second electronic apparatus.

The information processing method of the embodiments are described hereinbefore. In the information processing method of the embodiments, by acquiring a display image representing a virtual figure of the user and modifying the virtual figure based on representation of the user in the procedure of communication (for example, change in expression or action or the like) and transmitting the modified display image to other party of the communication in the procedure of communication, so as to make the user of the other party of the communication to experience the representation of the user in the procedure of communication synchronously and really without exposing the true figure of the user in the procedure of communication, as compared to a manner of only replacing by any image such as a cartoon figure or the like, feeling of reality and presence of a face to face communication is increased, so as to enrich and improve the user's experience greatly.

Further, in the information processing method of the embodiments, since the electronic apparatus at a user side only transmits the feature information after analyzing the image rather than the video image information collected by the camera head to the server and/or the electronic apparatus of a side of the other party of the communication only needs to receive virtual figure information rather than the video image information collected by the camera head from the server, the amount of data transmitted thereof is less than that in a case which the two parties of the communication transmits/receives the video image information collected by the camera head, therefore, the information processing method and the information processing apparatus of the embodiments can reduce the amount of data transmitted and increases communication efficiency to make the communication more smooth.

In particular, with the information processing method of the embodiments, the first electronic apparatus and/or the second electronic apparatus can select to transmit video image information collected by the camera head or the above-described information of the virtual figure according to a status of network communication.

More particularly, the first medium information may also include the first video information of the first user collected by the first electronic apparatus. Before generating the second display image, at least one of the first electronic apparatus, the second electronic apparatus and the server may detect communication status information representing communication status of the communication link, for example, information including parameters such as an upsteam transmission rate, a downstream transmission rate, a package loss rate, a network bandwidth or the like. In case that the first electronic apparatus and/or the second electronic apparatus detects the communication status information, the first electronic apparatus and/or the second electronic apparatus further transmit the detected communication status information to the server. Therefore, the server acquires the communication status information and determines whether the communication status information satisfies a switching condition. The switching condition may be set arbitrarily by the server as necessary. For example, the information processing method may determine whether a transmission rate is lower than a predetermined threshold. Also for example, the information processing method may determine whether a network bandwidth is lower than a predetermined threshold, and so on. Of course, the above switching conditions are only examples. Those skilled in the art can set the switching condition correspondingly according to different parameters included in the communication status information.

The information processing method generates the second display image and transmits the second display image and the first voice information to the second electronic apparatus by the above-described processing in case that the communication status information satisfies the switching condition. On the other hand, the information processing method transmits the first voice information and the first video information to the second electronic apparatus in case that the communication status information does not satisfy the switching condition. Amount of data transmitted of the second display image is less than amount of data transmitted of the first video information.

It needs to note that, it is described by taking determining whether the switching condition is satisfied and corresponding switch processing being executed at the server side as example. Those skilled in the art should understand that, the above-described processing of determining and switching may be executed at the first electronic apparatus and/or the second electronic apparatus of the terminal side similarly.

That is, the information processing method of the embodiments can select corresponding transmission image automatically according to the network communication. In term of the electronic apparatus at a transmitting side (the first electronic apparatus), when the status of network communications is better, that is, when the switching condition is not satisfied, the first electronic apparatus transmits the video image of the user collected by the camera head thereof to the server, and the video image is forwarded to the second electronic apparatus of the other party of communication by the server, so as to make the user of the other party of communication to be able to feel a sense of a face to face communication more really. On the other hand, when the status of network communications is poor, that is, when the switching condition is satisfied, the first electronic apparatus transmits the first feature information generated through the above-described processing to the server, and the server generates the virtual figure based on the first feature information and forwards it to the second electronic apparatus, so as to make the amount of data transmitted of the first electronic apparatus to be reduced significantly, and make the communication more smooth while being able to make the user of the other party of communication has a better feeling of reality and intimation, which improves the communication efficiency.

On the other hand, in term of the electronic apparatus at a receiving side (the second electronic apparatus), when the status of network communications is good, that is, when the switching condition is not satisfied, the second electronic apparatus receives the video image of the user collected by the camera head of the first electronic apparatus to the server, so as to be able to feel the sense of the face to face communication more really. On the other hand, when the status of network communications is poor, that is, when the switching condition is satisfied, the second electronic apparatus receives the virtual figure whose size is less than that of the video image significantly from the server, so as to be able to make the communication more smooth while making the user have better feeling of reality and intimation of the communication, which improves the communication efficiency.

Hereinbefore, the information processing method of the embodiments applied in the server is described with reference to FIG. 1.

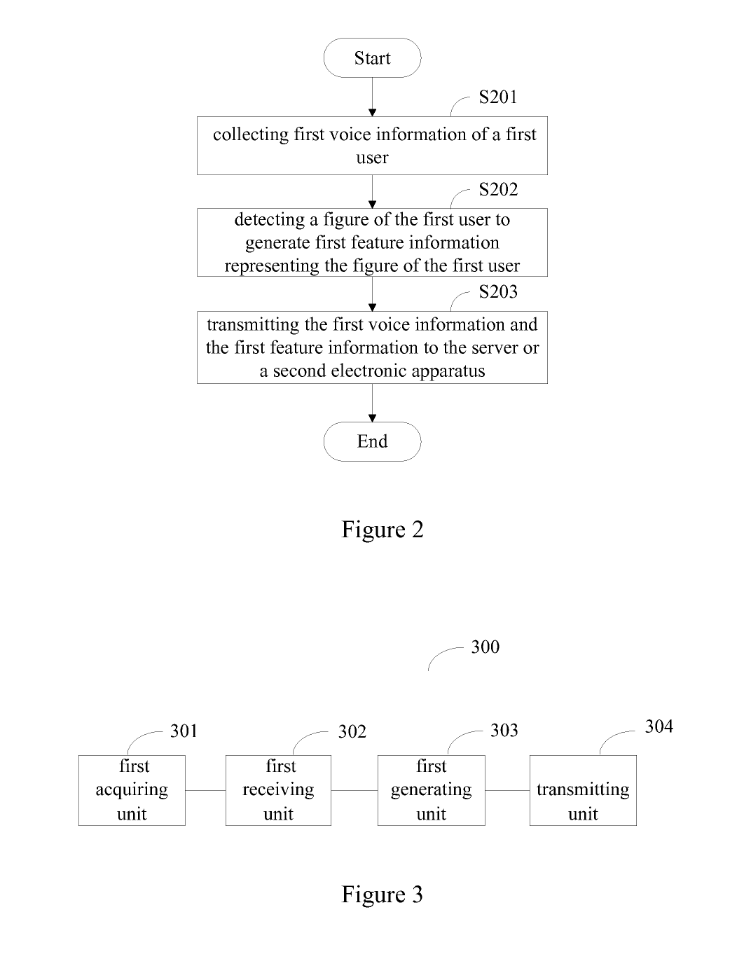

Hereinafter, an information processing method of another embodiment is described with reference to FIG. 2.

The information processing method of this embodiment is applied in an electronic apparatus. The electronic apparatus is an electronic apparatus having communication function for example a mobile phone, a tablet computer or a PC or the like. The electronic apparatus communicates with another electronic apparatus through a server. Hereinafter, for convenience of description, the electronic apparatus is referred as a first electronic apparatus and the other party of the communication of the first electronic apparatus is referred as a second electronic apparatus.

As shown in FIG. 2, firstly, in step S201, the information processing method collects first voice information of a first user in response to establishment of a communication link between the first electronic apparatus and a second electronic apparatus.

Next, in step S202, the information processing method detects a figure of a first user to generate first feature information representing the figure of the first user.

Then, in step S203, the information processing method transmits the first voice information and the first feature information to the server as first medium information to make the server to execute a modifying operation based on the first medium information and transmit the first voice information and a second display image as a result of the modifying operation to the second electronic apparatus; Or transmits the first voice information and the first feature information to the second electronic apparatus to make the second electronic apparatus execute the modifying operation. The modifying operation includes acquiring the first display image and modifying the first display image based on the first medium information to generate the second display image. The second electronic apparatus outputs the second display image and the first voice information.

The above detailed processing of steps S201-S203 has been already described in the information processing method with reference to FIG. 1, and it is no longer repeated here.

It needs to note that, as explained in the above, the modifying operation for modifying the first display image based on the first medium information to generate the second display image may be executed at the server side as in the above embodiment, so as to reduce processing burden at the terminal side. Alternatively, in case that processing capacity at the terminal side is relatively strong, modifying operation may also be executed at the electronic apparatus of the receiving side, so that the server only needs to forward the first medium information including the first feature information without forwarding the first video information, so as to further reduce the amount of data transmitted and improve the communication efficiency.

Further, in another embodiment, the information processing method may further includes: collecting the first video information of the first user by a camera unit in response to the establishment of the communication link between the first electronic apparatus and the second electronic apparatus; detecting the communication status information representing the communication status of the communication link; determining whether the communication status information satisfies the switching condition; Transmitting the first voice information and the first feature information as the first medium information to the server in case that the communication status information satisfies the switching condition; transmit the first voice information and the first video information to the second electronic apparatus through the server in case that the communication status information does not satisfy the switching condition. The amount of data transmitted of the second display image is less than the amount of data transmitted of the first video information.

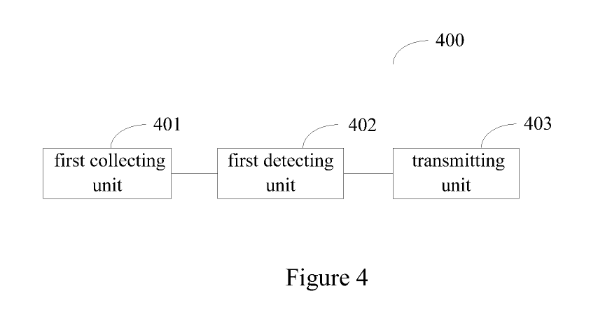

Hereinbefore, the information processing method of the embodiments is described with reference to FIG. 1 and FIG. 2. Hereinafter, the information processing apparatus of the embodiments is described with reference to FIG. 3 and FIG. 4.

Firstly, with reference to FIG. 3, it illustrates the information processing apparatus of the embodiments. The information processing apparatus is applied in a server. As shown in FIG. 3, the information processing apparatus 300 of the embodiments includes: a first acquiring unit 301, a first receiving unit 302, a first generating unit 303 and a transmitting unit 304.

The first acquiring unit 301 acquires a first display image of a first user of a first electronic apparatus in response to establishment of a communication link between the first electronic apparatus and a second electronic apparatus.

The first receiving unit 302 receives, from the first electronic apparatus, first medium information including first voice information of the first user collected by the first electronic apparatus and first feature information representing feature of the first user.

The first generating unit 303 modifies the first display image based on the first medium information to generate the second display image.

The transmitting unit 304 transmits the second display image and the first voice information to the second electronic apparatus to output the second display image and the first voice information at the second electronic apparatus.

In one embodiment, the information processing apparatus 300 further includes: a second acquiring unit, a second receiving unit and a second generating unit. The second acquiring unit acquires a third display image. The second receiving unit receives adjustment information from the first electronic apparatus, and the adjustment information is generated by detecting the feature of the first user by the first electronic apparatus or generated by receiving instruction of the first user by the first electronic apparatus. The second generating unit generates the first display image based on the third display image and the adjustment information.

In another embodiment, the second acquiring unit is configured to: select the third display image from a plurality of candidate images based on a predetermined strategy according to reference information received from the first electronic apparatus.

In another embodiment, the first generating unit 303 includes: a first modifying unit for modifying the first display image based on the first feature information included in the first medium information to generate the second display image.

In another embodiment, the first generating unit 303 includes: a recognizing unit for executing voice recognition to the first voice information in the first medium information to obtain second feature information; and a second modifying unit for modifying the first display image based on the second feature information to generate the second display image.

In another embodiment, the information processing apparatus 300 further include: a recognizing unit for recognizing the first voice information; a converting unit for converting the recognized first voice information to generate converted first voice information and third feature information; and, the first generating unit 303 includes: a third modifying unit for modifying the first virtual figure based on the first feature information and the third feature information to generate the second display image; the transmitting unit 304 is configured to: transmit the second display image and the converted first voice information to the second electronic apparatus to output the second display image and the converted first voice information at the second electronic apparatus.

In another embodiment, the first medium information further includes first video information of the first user collected by the first electronic apparatus, and the information processing apparatus 300 further includes: a third acquiring unit for acquiring communication status information representing communication status of the communication link before generating the second display image, the communication status information being received from at least one of the first electronic apparatus and the second electronic apparatus or detected by the server; a determining unit for determining whether the communication status information satisfies a switching condition; and the transmitting unit 304 is configured to generate the second display image and transmit the second display image and the first voice information to the second electronic apparatus in case that the communication status information satisfies the switching condition; transmit the first video information and the first voice information to the second electronic apparatus in case that the communication status information does not satisfy the switching condition, wherein, amount of data transmitted of the second display image is less than amount of data transmitted of the first video information.

Configuration and operation of the respective units of the information processing apparatus 300 have been described detailed in the information processing method with reference to FIG. 1, and it is no longer repeat here.

Hereinafter, an information processing apparatus of another embodiment is described with reference to FIG. 4. The information processing apparatus of the embodiments applied in an electronic apparatus, and hereinafter it is referred as a first electronic apparatus. As shown in FIG. 4, the information processing apparatus 400 of the embodiments includes: a first collecting unit 401, a first detecting unit 402 and a transmitting unit 403.

The first collecting unit 401 collects first voice information of a first user in response to establishment of a communication link between the first electronic apparatus and a second electronic apparatus.

The first detecting unit 402 detects a figure of the first user to generate first feature information representing the figure of the first user.

The transmitting unit 403 transmits the first voice information and the first feature information to the server as first medium information to make the server to execute a modifying operation based on the first medium information and transmit the first voice information and a second display image as a result of the modifying operation to the second electronic apparatus; or transmit the first voice information and the first feature information to the second electronic apparatus to make the second electronic apparatus execute the modifying operation; wherein, the modifying operation includes: acquiring the first display image and modifying the first display image based on the first medium information to generate the second display image.

In one embodiment, the information processing apparatus 400 further includes: a second collecting unit for collecting first video information of the first user by a camera unit in response to the establishment of the communication link between the first electronic apparatus and the second electronic apparatus; a second detecting unit for detecting communication status information representing communication status of the communication link; a determining unit for determining whether the communication status information satisfies a switching condition; the transmitting unit 403 is configured to transmit the first voice information and the first feature information as the first medium information to the server in case that the communication status information satisfies the switching condition; and transmit the first voice information and the first video information to the second electronic apparatus through the server in case that the communication status information does not satisfy the switching condition.

In another embodiment, amount of data transmitted of the second display image is less than amount of data transmitted of the first video information.

Hereinbefore, the information processing apparatus of the embodiments is described with reference to FIG. 3 and FIG. 4. In the information processing apparatus of the embodiments, by acquiring the display image representing the virtual figure of the user and modifying the virtual figure based on representation of the user in the procedure of communication (for example, change in expression or action or the like) and transmitting the modified display image to other party of the communication in the procedure of communication, so as to make the user of the other party of the communication to experience the representation of the user in the procedure of communication synchronously and really without exposing the true figure of the user in the procedure of communication, as compared to the manner of only replacing by any image such as the cartoon figure or the like, feeling of reality and presence of the face to face communication is increased, so as to enrich and improve the user's experience greatly.

Further, in the information processing apparatus of the embodiments, since the electronic apparatus at the user side only transmits the feature information after analyzing the image rather than the video image information collected by the camera head to the server and/or the electronic apparatus of the side of the other party of the communication only needs to receive virtual figure information rather than the video image information collected by the camera head from the server, the quantity of data transmitted thereof is less than that in the case which the two parties of the communication transmits/receives the video image information collected by the camera head, therefore, the information processing apparatus and the information processing apparatus of the embodiments can reduce the quantity of data transmitted and increases communication efficiency to make the communication more smooth.

Hereinbefore, the information processing method and the information processing apparatus according to the embodiments are described with reference to FIG. 1 to FIG. 4.

In the information processing method and the information processing apparatus of the embodiments, by acquiring a display image representing a virtual figure of the user and modifying the virtual figure based on representation of the user in the procedure of communication (for example, change in expression or action or the like) and transmitting the modified display image to other party of the communication in the procedure of communication, so as to make the user of the other party of the communication to experience the representation of the user in the procedure of communication synchronously and really without exposing the true figure of the user in the procedure of communication, as compared to a manner of only replacing by any image such as a cartoon figure or the like, feeling of reality and presence is increased and the user's experience is enriched and improved greatly.

Further, in the information processing method and the information processing apparatus of the embodiments, since the electronic apparatus at a user side only transmits the feature information after analyzing the image rather than the video image information collected by the camera head to the server and/or the electronic apparatus of a side of the other party of the communication only needs to receive virtual figure information rather than the video image information collected by the camera head from the server, the amount of data transmitted thereof is less than that in a case which the two parties of the communication transmits/receives the video image information collected by the camera head, therefore, the information processing method and the information processing apparatus of the embodiments can reduce the amount of data transmitted and increases communication efficiency to make the communication more smooth.

It needs to explain that, in the specification, terms of “comprise”,“include: and any other variations thereof intends to cover non-exclusive inclusion so that a procedure, a method, a product or an equipment including a series of elements not only includes these elements, but also include other elements which are not listed explicitly, or also include inherent elements of these procedure, method, product or equipment. In case that there is no more limitation, the element defined by a statement “including one . . . ” does not exclude there is additional same element in the procedure, method, article or apparatus including the element.

Further, it needs to explain that, in the specification, expressions such as “a first unit”,“a second . . . unit” are only for distinguishing for convenience at the time of describing, and it does not mean that it must be implemented as two or more units separated physically. Actually, the units may be implemented as one unit whole, or may be implemented as a plurality of units as necessary.

Finally, it should note that, the above-described a series of processing does not only include processing executed chronologically in order mentioned here, and also include processing executed parallel or individually but not chronologically.

With the description of the above implementation mode, those skilled in the art can clearly understand that this disclosure can be implemented by means of software plus necessary hardware platform, and, of course, it can be implemented by hardware totally. Based on such understanding, the technical solution of this disclosure essentially or the part contributed to the conventional description can be embodied by a form of a software product, the computer software product can be stored in a storage medium, such as a ROM/RAM, a magnetic disc, an optical disk or the like, it includes some instructions to cause a computer equipment (it may be a personal computer, a server or a network equipment or the like) to execute the method according to the respective embodiments of a certain part of the embodiments.

In the embodiments, the unit/module can be implemented with software to be processed by various kinds of processors. For example, one identified executable code module may include one or more of physical or logical block of computer instructions, for example, which can be constructed as an object, a procedure or a function. Nevertheless, the executable code of the identified modules is not necessary to be together physically, but may include different instructions stored in different bits, and when these instructions are combined together logically, they constitutes the units/modules and implement specific purpose of the units/modules.

When the units/modules are implemented with software, in consideration of level of the conventional hardware process, the units/modules may be implemented with software. However, when it takes no account of cost, those skilled in the art can build corresponding hardware circuit to implement corresponding functions, and the hardware circuit includes conventional very large-scale integrated (VLSI) circuit or gate array and the conventional semiconductor such as a logic chip, a transistor or the like or other discrete elements. The modules may also be implemented by a programmable hardware apparatus such as a FPGA, programmable array logic, a programmable logic utility or the like.

This disclosure is described detailed above, the principle and the implementation mode of this disclosure are explained by applying specific example in the text, and the above explanation of the embodiments is only for understanding the method of this disclosure and the kernel idea thereof; meanwhile, for those skilled in the art, the specific implementation mode and range of this disclosure may be changed according to the idea of this disclosure, thus in summary, the content in the specification should not be understood as a limitation to this disclosure.

1. An information processing method comprising:
acquiring a first display image of a first user of a first electronic apparatus in response to establishment of a communication link between the first electronic apparatus and a second electronic apparatus;
receiving, from the first electronic apparatus, first medium information including first voice information of the first user collected by the first electronic apparatus and first feature information representing feature of the first user;
modifying the first display image based on the first medium information to generate a second display image; and
transmitting the second display image and the first voice information to the second electronic apparatus to output the second display image and the first voice information at the second electronic apparatus.

2. The information processing method according to claim 1, wherein the first display image is generated by the following steps:
acquiring a third display image;
receiving adjustment information from the first electronic apparatus, wherein the adjustment information is generated by detecting the feature of the first user by the first electronic apparatus or generated by receiving instruction of the first user by the first electronic apparatus; and
generating the first display image based on the third display image and the adjustment information.

3. The information processing method according to claim 2, wherein the step of acquiring the third display image comprises selecting the third display image from a plurality of candidate images based on a predetermined strategy according to reference information received from the first electronic apparatus.

4. The information processing method according to claim 1, wherein the step of generating the second display image comprises modifying the first display image based on the first feature information included in the first medium information to generate the second display image.

5. The information processing method according to claim 1 wherein, the step of generating the second display image comprises:
executing voice recognition to the first voice information in the first medium information to obtain second feature information; and
modifying the first display image based on the second feature information to generate the second display image.

6. The information processing method according to claim 1, further comprising:
recognizing the first voice information;
converting the recognized first voice information to generate converted first voice information and third feature information;
wherein the step of generating the second display image comprises modifying the first display image based on the first feature information and the third feature information to generate the second display image; and the step of transmitting the second display image and the first voice information to the second electronic apparatus comprises transmitting the second display image and the converted first voice information to the second electronic apparatus to output the second display image and the converted first voice information at the second electronic apparatus.

7. The information processing method according to claim 1, wherein the first medium information further includes first video information of the first user collected by the first electronic apparatus, and the information processing method further comprises:
acquiring communication status information representing communication status of the communication link before generating the second display image, wherein the communication status information is received from at least one of the first electronic apparatus and the second electronic apparatus or detected by a server;
determining whether the communication status information satisfies a switching condition; and
generating the second display image and transmitting the second display image and the first voice information to the second electronic apparatus in the case that the communication status information satisfies the switching condition; transmitting the first video information and the first voice information to the second electronic apparatus in the case that the communication status information does not satisfy the switching condition,
wherein, amount of data transmitted of the second display image is less than amount of data transmitted of the first video information.

8. An information processing method, comprising:
collecting first voice information of a first user in response to establishment of a communication link between a first electronic apparatus and a second electronic apparatus;
detecting a figure of the first user to generate first feature information representing the figure of the first user; and
transmitting the first voice information and the first feature information to a server as first medium information to make the server execute a modifying operation based on the first medium information and transmit the first voice information and a second display image as a result of the modifying operation to the second electronic apparatus; or transmitting the first voice information and the first feature information to the second electronic apparatus to make the second electronic apparatus execute the modifying operation;
wherein, the modifying operation includes acquiring the first display image; and modifying the first display image based on the first medium information to generate the second display image.

9. The information processing method according to claim 8, further comprising:
collecting first video information of the first user by a camera unit in response to the establishment of the communication link between the first electronic apparatus and the second electronic apparatus;
detecting communication status information representing a communication status of the communication link;
determining whether the communication status information satisfies a switching condition; and
transmitting the first voice information and the first feature information as the first medium information to the server in the case that the communication status information satisfies the switching condition; transmitting the first voice information and the first video information to the second electronic apparatus through the server in the case that the communication status information does not satisfy the switching condition.

10. The information processing method according to claim 9, wherein an amount of data transmitted of the second display image is less than an amount of data transmitted of the first video information.

11. An information processing apparatus comprising:
a first acquiring unit for acquiring a first display image of a first user of a first electronic apparatus in response to establishment of a communication link between the first electronic apparatus and a second electronic apparatus;
a first receiving unit for receiving, from the first electronic apparatus, first medium information including first voice information of the first user collected by the first electronic apparatus and first feature information representing feature of the first user;
a first generating unit for modifying the first display image based on the first medium information to generate a second display image; and
a transmitting unit for transmitting the second display image and the first voice information to the second electronic apparatus to output the second display image and the first voice information at the second electronic apparatus.

12. The information processing apparatus according to claim 11, further comprising:
a second acquiring unit for acquiring a third display image;
a second receiving unit for receiving adjustment information from the first electronic apparatus, wherein the adjustment information is generated by detecting the feature of the first user by the first electronic apparatus or generated by receiving instruction of the first user by the first electronic apparatus; and
a second generating unit for generating the first display image based on the third display image and the adjustment information.

13. The information processing apparatus according to claim 12, wherein the second acquiring unit is configured to select the third display image from a plurality of candidate images based on a predetermined strategy according to reference information received from the first electronic apparatus.

14. The information processing apparatus according to claim 11, wherein the first generating unit comprises a first modifying unit for modifying the first display image based on the first feature information included in the first medium information to generate the second display image.

15. The information processing apparatus according to claim 11, wherein the first generating unit comprises:
a recognizing unit for executing voice recognition to the first voice information in the first medium information to obtain second feature information; and
a second modifying unit for modifying the first display image based on the second feature information to generate the second display image.

16. The information processing apparatus according to claim 11, further comprising:
a recognizing unit for recognizing the first voice information;
a converting unit for converting the recognized first voice information to generate converted first voice information and third feature information;
wherein the first generating unit comprises a third modifying unit for modifying the first display image based on the first feature information and the third feature information to generate the second display image and wherein the transmitting unit further transmits the second display image and the converted first voice information to the second electronic apparatus to output the second display image and the converted first voice information at the second electronic apparatus.

17. The information processing apparatus according to claim 11, wherein the first medium information further includes first video information of the first user collected by the first electronic apparatus and the information processing apparatus further comprises:
a third acquiring unit for acquiring communication status information representing a communication status of communication link before generating the second display image, wherein the communication status information is received from at least one of the first electronic apparatus and the second electronic apparatus or detected by a server;
a determining unit for determining whether the communication status information satisfies a switching condition;
wherein the transmitting unit is configured to generate the second display image and transmit the second display image and the first voice information to the second electronic apparatus in the case that the communication status information satisfies the switching condition; transmit the first video information and the first voice information to the second electronic apparatus in the case that the communication status information does not satisfy the switching condition, and
wherein an amount of data transmitted of the second display image is less than an amount of data transmitted of the first video information.

18. An information processing apparatus comprising:
a first collecting unit for collecting first voice information of a first user in response to establishment of a communication link between a first electronic apparatus and a second electronic apparatus;
a first detecting unit for detecting a figure of the first user to generate first feature information representing the figure of the first user; and
a transmitting unit for transmitting the first voice information and the first feature information to a server as first medium information to make the server to execute a modifying operation based on the first medium information and transmit the first voice information and a second display image as a result of the modifying operation to the second electronic apparatus; or transmitting the first voice information and the first feature information to the second electronic apparatus to make the second electronic apparatus execute the modifying operation;
wherein, the modifying operation comprises: acquiring the first display image and modifying the first display image based on the first medium information to generate the second display image.

19. The information processing apparatus according to claim 18, further comprising:
a second collecting unit for collecting first video information of the first user by a camera unit in response to the establishment of the communication link between the first electronic apparatus and the second electronic apparatus;
a second detecting unit for detecting communication status information representing a communication status of the communication link; and
a determining unit for determining whether the communication status information satisfies a switching condition;
wherein the transmitting unit is configured to transmit the first voice information and the first feature information as the first medium information to the server in the case that the communication status information satisfies the switching condition;
transmit the first voice information and the first video information to the second electronic apparatus through the server in the case that the communication status information does not satisfy the switching condition.

20. The information processing apparatus according to claim 19, wherein an amount of data transmitted of the second display image is less than an amount of data transmitted of the first video information.
